(19) United States
(12) Patent Application Publication
(10) Pub. No.: US 2009/0002324 A1
(43) Pub. Date: Jan. 1, 2009

(54) Method, Apparatus and Computer Program Product for Providing a Scrolling Mechanism for Touch Screen Devices

(75) Inventors: Peter Harbeson, Hampton, NH (US); Yael Aharon, Lexington, MA (US); Sherman Horton, Chelmsford, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/769,187

(22) Filed: Jun. 27, 2007

(51) Int. Cl. G06F 3/041

(52) U.S. Cl. 345/173

(57) ABSTRACT

An apparatus for providing a scrolling mechanism for touch screen devices may include a detector, a scroll cursor generator and a scrolling device. The detector may be configured to receive an indication of a detection of a touch event at a touch screen display generating a content view of at least a portion of a content page. The scroll cursor generator may be in communication with the detector and may be configured to generate a scroll cursor at a touch position corresponding to movement of an object associated with the touch event. The scrolling device may be in communication with the scroll cursor generator and may be configured to provide scrolling over the content page in response to the scroll cursor contacting a predefined portion of the content view.

### TECHNOLOGICAL FIELD

Embodiments of the present invention relate generally to user interface technology and, more particularly, relate to a method, apparatus, and computer program product for providing a scrolling mechanism for touch screen devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. A user's experience during certain applications such as, for example, web browsing may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays. As such, touch screen devices are now relatively well known in the art, with numerous different technologies being employed for sensing a particular point at which an object may contact the touch screen display.

In certain environments, such as when used in connection with a mobile terminal or other device having a relatively small display, scrolling may be an important part of the user interface. In this regard, for example, when a web page or a document is displayed on a device having a relatively small display, it is common for only a portion of the web page or document to be displayed, with remaining portions of the web page or document being accessible by scrolling. A common mechanism for scrolling in such situations has been a scroll bar. In some situations separate scroll bars have been provided to permit scrolling in cardinal directions (e.g., the four primary directions with respect to the display such as up, down, left and right). However, such scrolling mechanisms can be cumbersome since they require separate interfaces in order to scroll in different directions and are often difficult to use with a finger touch due to the relatively small size of the scroll bars.

In order to improve scrolling performance, mechanisms for “grabbing” a page and moving the page across the screen have been developed to permit scrolling in directions other than the cardinal directions and ease the impact of small scroll bars. However, this mechanism may also become cumbersome in certain situations such as when scrolling over a long distance since the page can only be moved as far as one screen length in a single grab-and-move operation. Thus, for long distance scrolling, repeated grab-and-move operations are required.

Accordingly, it may be desirable to provide a mechanism for overcoming at least some of the disadvantages discussed above.

### BRIEF SUMMARY

A method, apparatus and computer program product are therefore provided for providing a scrolling mechanism for touch screen devices. In particular, a method, apparatus and computer program product are provided that enable “bubble” scrolling which may provide improved scrolling functionality that may be of particular use in small display environments. However, the advantages of bubble scrolling may also be realized in other environments including large screen environments as well since bubble scrolling provides an intuitive and easy to use scrolling mechanism. In this regard, a scroll cursor may be defined relative to a touch event location in response to a stroke action following the touch event on a touch screen display. The scroll cursor may have various shapes including a circular or bubble shape such that when an external boundary of the scroll cursor contacts an edge of a content display, the page associated with the content that is displayed may scroll in a proportional manner.

In one exemplary embodiment, a method of providing a scrolling mechanism for touch screen devices is provided. The method may include receiving an indication of a detection of a touch event at a touch screen display generating a content view of at least a portion of a content page, generating a scroll cursor at a touch position corresponding to movement of an object associated with the touch event, and scrolling over the content page in response to the scroll cursor contacting a predefined portion of the content view.

In another exemplary embodiment, a computer program product for providing a scrolling mechanism for touch screen devices is provided. The computer program product includes at least one computer-readable storage medium having computer-readable program code portions stored therein. The computer-readable program code portions include first, second and third executable portions. The first executable portion is for receiving an indication of a detection of a touch event at a touch screen display generating a content view of at least a portion of a content page. The second executable portion is for generating a scroll cursor at a touch position corresponding to movement of an object associated with the touch event. The third executable portion is for scrolling over the content page in response to the scroll cursor contacting a predefined portion of the content view.

In another exemplary embodiment, an apparatus for providing a scrolling mechanism for touch screen devices is provided. The apparatus may include a detector, a scroll cursor generator and a scrolling device. The detector may be configured to receive an indication of a detection of a touch event at a touch screen display generating a content view of at least a portion of a content page. The scroll cursor generator may be in communication with the detector and may be configured to generate a scroll cursor at a touch position corresponding to movement of an object associated with the touch event. The scrolling device may be in communication with the scroll cursor generator and may be configured to provide scrolling over the content page in response to the scroll cursor contacting a predefined portion of the content view.

In another exemplary embodiment, an apparatus for providing a scrolling mechanism for touch screen devices is provided. The apparatus includes means for receiving an indication of a detection of a touch event at a touch screen display generating a content view of at least a portion of a content page, means for generating a scroll cursor at a touch position corresponding to movement of an object associated with the touch event, and means for scrolling over the content page in response to the scroll cursor contacting a predefined portion of the content view.

Embodiments of the invention may provide a method, apparatus and computer program product for improving touch screen interface performance. As a result, for example, mobile terminal users may enjoy improved capabilities with respect to web browsing and other services or applications that may be used in connection with a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing a scrolling mechanism for touch screen devices according to an exemplary embodiment of the present invention;

FIG. 3 illustrates a content view showing a portion of an exemplary web page which may be scrolled over using a scroll cursor according to an exemplary embodiment of the present invention;

FIG. 4 illustrates another content view with the scroll cursor positioned for scrolling according to an exemplary embodiment of the present invention;

FIG. 5 illustrates another content view with the scroll cursor positioned for scrolling according to another exemplary embodiment of the present invention;

FIG. 6 illustrates another content view with the scroll cursor positioned for scrolling according to yet another exemplary embodiment of the present invention; and

FIG. 7 is a block diagram according to an exemplary method for providing a scrolling mechanism for touch screen devices according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

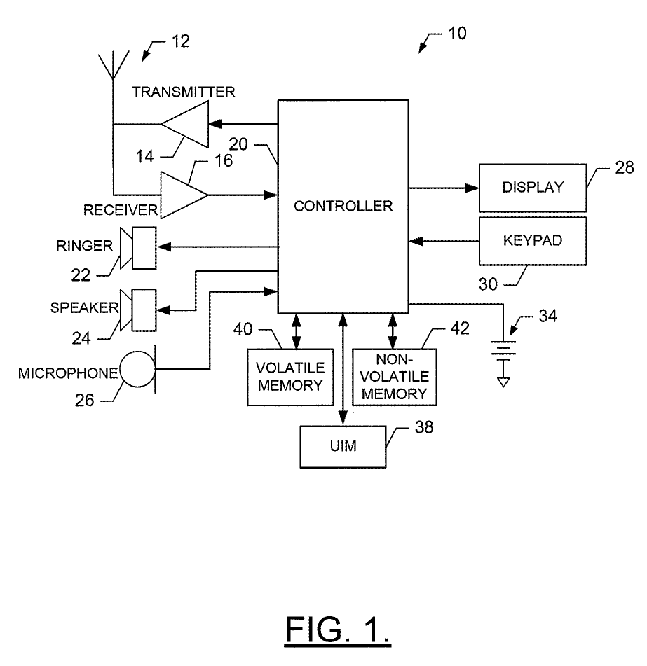

FIG. 1 illustrates a block diagram of a mobile terminal 10 that would benefit from embodiments of the present invention. It should be understood, however, that a mobile telephone as illustrated and hereinafter described is merely illustrative of one type of device that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a touch display 28, and a user input interface, all of which are coupled to the controller 20. The user input interface, which allows the mobile terminal 10 to receive data, may include any of a number of devices allowing the mobile terminal 10 to receive data, such as a keypad 30, the touch display 28 or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

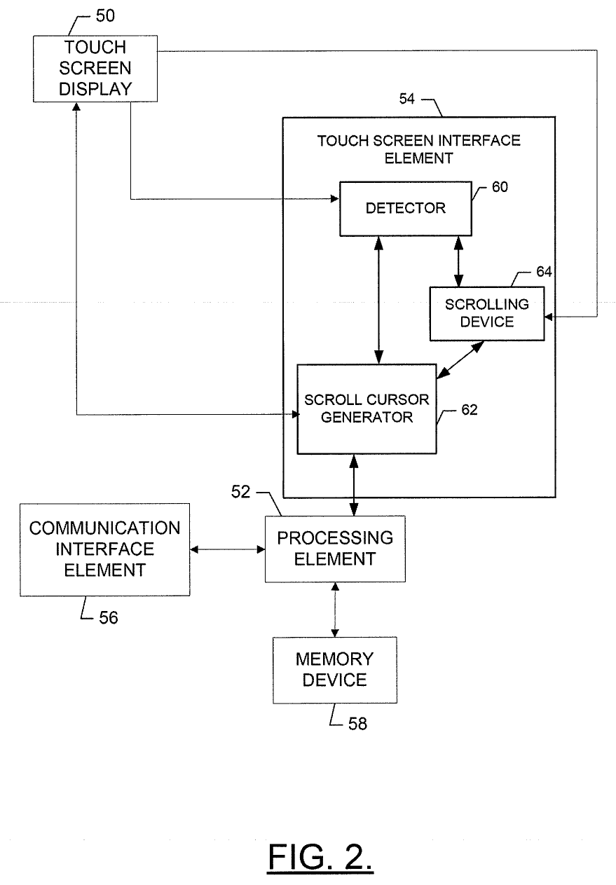

An exemplary embodiment of the invention will now be described with reference to FIG. 2, in which certain elements of a system for providing a scrolling mechanism for touch screen devices are displayed. The system of FIG. 2 may be employed, for example, in conjunction with the mobile terminal 10 of FIG. 1. However, it should be noted that the system of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of a system for providing a scrolling mechanism for touch screen devices, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element. Moreover, although an exemplary embodiment of the present invention described below will generally refer to scrolling in the context of a web browsing application (e.g., scrolling over a portion of a web page), embodiments of the present invention more generally relate to scrolling over any page, document, screen, etc. over which only a portion of such page, document, screen, etc. may be displayed at a given time.

Referring now to FIG. 2, an apparatus for providing an object selection mechanism for touch screen devices is provided. The apparatus may include a touch screen display 50 (e.g., the display 28) a processing element 52 (e.g., the controller 20), a touch screen interface element 54, a communication interface element 56 and a memory device 58. The memory device 58 may include, for example, volatile and/or non-volatile memory (e.g., volatile memory 40 and/or non-volatile memory 42). The memory device 58 may be configured to store information, data, applications, instructions or the like for enabling the apparatus to carry out various functions in accordance with exemplary embodiments of the present invention. For example, the memory device 58 could be configured to buffer input data for processing by the processing element 52. Additionally or alternatively, the memory device 58 could be configured to store instructions for execution by the processing element 52.

The processing element 52 may be embodied in a number of different ways. For example, the processing element 52 may be embodied as a processor, a coprocessor, a controller or various other processing means or devices including integrated circuits such as, for example, an ASIC (application specific integrated circuit). In an exemplary embodiment, the processing element 52 may be configured to execute instructions stored in the memory device 58 or otherwise accessible to the processing element 52. Meanwhile, the communication interface element 56 may be embodied as any device or means embodied in either hardware, software, or a combination of hardware and software that is configured to receive and/or transmit data from/to a network and/or any other device or module in communication with the apparatus.

The touch screen display 50 may be embodied as any known touch screen display. Thus, for example, the touch screen display 50 could be configured to enable touch recognition by any suitable technique, such as resistive, capacitive, infrared, strain gauge, surface wave, optical imaging, dispersive signal technology, acoustic pulse recognition, etc. techniques. The touch screen interface element 54 may be in communication with the touch screen display 50 to receive indications of user inputs at the touch screen display 50 and to modify a response to such indications based on corresponding user actions that may be inferred or otherwise determined responsive to the indications. In this regard, the touch screen interface element 54 may be any device or means embodied in either hardware, software, or a combination of hardware and software configured to perform the respective functions associated with the touch screen interface element 54 as described below. In an exemplary embodiment, the touch screen interface element 54 may be embodied in software as instructions that are stored in the memory device 58 and executed by the processing element 52. Alternatively, touch screen interface element 54 may be embodied as the processing element 52.

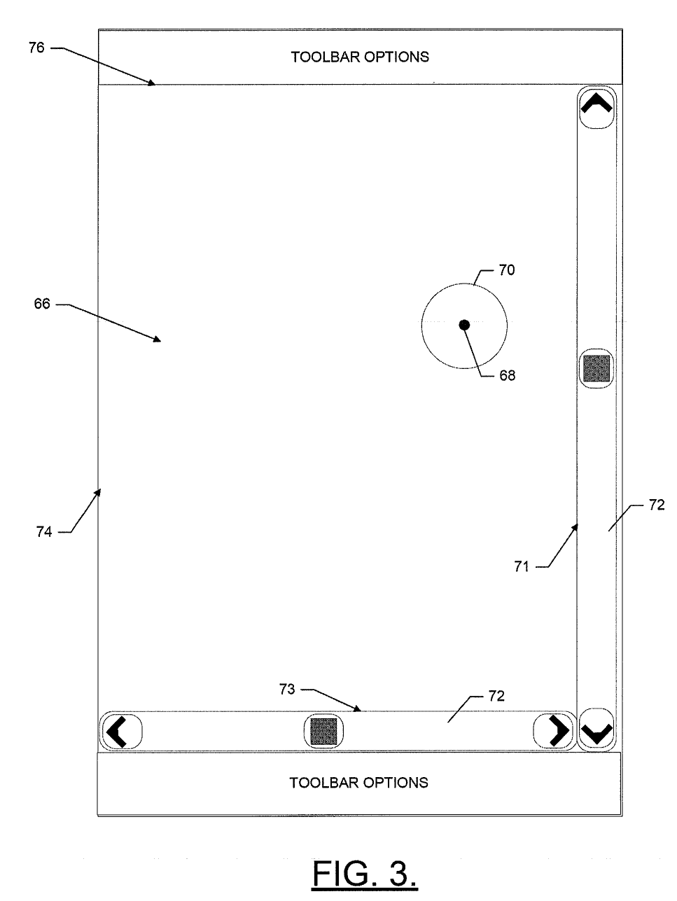

The touch screen interface element 54 may be configured to receive an indication of an input in the form of a touch event at the touch screen display 50. Following recognition of the touch event, the touch screen interface element 54 may be configured to thereafter determine a stroke event and provide a corresponding scroll function based on the stroke event. In this regard, the touch screen interface element 54 may include a detector 60, a scroll cursor generator 62 and a scrolling device 64. Each of the detector 60, the scroll cursor generator 62 and the scrolling device 64 may be any device or means embodied in either hardware, software, or a combination of hardware and software configured to perform the corresponding functions associated with the detector 60, the scroll cursor generator 62 and the scrolling device 64, respectively, as described below. In an exemplary embodiment, each of the detector 60, the scroll cursor generator 62 and the scrolling device 64 may be controlled by or otherwise embodied as the processing element 52. Elements of the touch screen interface element 54 will now be described in reference to FIGS. 2 and 3. FIG. 3 illustrates a content view 66 showing a portion of an exemplary web page (or page) which may be scrolled over in connection with an embodiment of the present invention.

The detector 60 may be in communication with the touch screen display 50 to receive indications of user inputs in order to recognize and/or determine a touch event based on each input received at the detector 60. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of touch screen display 50 above a particular pressure threshold over a given area. Subsequent to each touch event, the detector 60 may be further configured to recognize and/or determine a corresponding stroke event. A stroke event may be defined as a touch event followed immediately by motion of the object initiating the touch event while the object remains in contact with the touch screen display 50. In other words, the stroke event may be defined by motion following a touch event thereby forming a continuous, moving touch event defining a moving series of instantaneous touch positions (e.g., touch position 68). For purposes of the description above, the term immediately should not necessarily be understood to correspond to a temporal limitation. Rather, the term immediately, while it may generally correspond to relatively short time after the touch event in many instances, instead is indicative of no intervening actions between the touch event and the motion of the object defining the touch position 68 while such object remains in contact with the touch screen display 50. However, in some instances in which a touch event that is held for a threshold period of time triggers a corresponding function, the term immediately may also have a temporal component associated in that the motion of the object causing the touch event must occur before the expiration of the threshold period of time.

In an exemplary embodiment, the detector 60 may be configured to communicate detection information regarding the recognition or detection of a stroke event to the scroll cursor generator 62. In response to receipt of the detection information, the scroll cursor generator 62 may generate a scroll cursor 70 in a fixed position relative to the touch event. The scroll cursor 70 may then be visualized on the touch screen display 50. In response to the stroke event, the scroll cursor generator 62 may be configured to generate the scroll cursor 70 to move corresponding to the movement of the touch position 68 in fixed proximity to the touch position 68 throughout the movement of the touch position 68. In an exemplary embodiment, the touch position 68 itself may be visualized with, for example, a “dot” or other marking that may move across the screen of the touch screen display 50 to indicate a current location of the object causing the detection of contact with the touch screen display 50. However, it is not necessary that the touch position 68 be marked or visualized.

The scroll cursor 70 may be a graphical element centered over the touch position 68. In an exemplary embodiment, the scroll cursor 70 may be a circle of a predefined radius (e.g., a “bubble”) extending from the touch position 68. The length of the radius may depend upon capabilities and/or settings of the touch screen display 50. For example, for higher resolution and/or larger displays, the length of the radius could be tailored to be proportionally, or inverse proportionally scaled in size. As an alternative, the length of the radius may depend upon the mode, scale, zoom settings, etc. of the page or document being viewed. In an exemplary embodiment, the scroll cursor 70 could be any other shape, including geometric and irregular shapes, or the scroll cursor 70 may even be a graphic such as a logo or image. In various embodiments, the area bounded or covered by the graphical element forming the scroll cursor 70 (e.g., the portion between the radius of the circle and the touch position 68) may be completely transparent, partially transparent or not transparent at all. The user may have the ability to select characteristics of the scroll cursor 70 (e.g., shape, color, transparency, size, graphic, etc.) via a toolbar menu or any other mechanism.

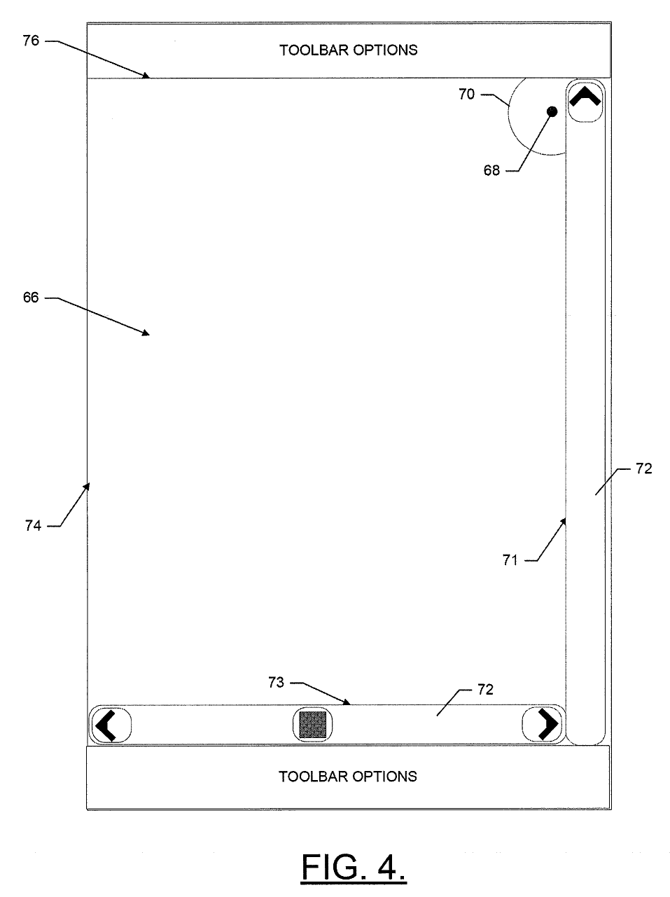

Once the scroll cursor 70 is visualized on the touch screen display 50, the movement of the scroll cursor 70 may be tracked by the scrolling device 64. The scrolling device 64 may be configured to scroll over the page in response to the scroll cursor 70 reaching the edge of the content view 66. As shown in FIG. 3, edges of the content view 66 may be defined by scroll bars 72 (e.g., the right edge 71 and the bottom edge 73 of the content view 66), by an edge of the touch screen display 50 (e.g. a left edge 74 of the content view 66), or by an edge of a viewing pane defining the content view 66 portion of the touch screen display 50 (e.g., the top edge 76). However, it should be noted that, although scroll bars and toolbar options are illustrated in FIGS. 3-6, the scroll bars and/or toolbar options may be left out or replaced by other objects. As such, edges of the content view 66 may be defined by edges of the touch screen display 50 or any other object. In response to the scrolling cursor 70 reaching an edge of the content view 66, the scrolling device 64 may be configured to scroll the page in a direction opposite to the directional edge of the content view 66 that is being contacted by the scroll cursor 70. In other words, if the scroll cursor 70 contacts the right edge 71 of the content view 66, the scrolling device 64 may be configured to scroll the page to the left. Meanwhile, as shown in FIG. 4, if the scroll cursor 70 contacts the right edge 71 and the top edge 76 of the content view 66, the scrolling device 64 may be configured to scroll the page to the left and down. In an exemplary embodiment, the speed of scrolling may be directly proportional to an amount of the scroll cursor 70 that is in contact with (or in some cases obscured by or clipped by) a particular edge of the content view 66. In this regard, for example, a linear scale may be defined between a minimum and maximum scrolling speed such that, when an edge of the scroll cursor 70 first contacts a predefined portion (e.g., an edge) of the content view 66, scrolling begins to occur at the minimum scrolling speed. Then as more of the scroll cursor 70 contacts the predefined portion of the content view 66, the scrolling speed linearly increases until such time as the touch position 68 (i.e., the maximum amount of the scroll cursor 70) contacts the predefined portion of the content view 66, at which time the maximum scrolling speed is employed. Accordingly, for example, as shown in FIG. 4, since a larger portion of the scroll cursor 70 is in contact with the right edge 71 than the top edge 76, the page may be scrolled more (or faster) to the left than to the downward direction.

Simply moving the scroll cursor 70 around the content view 66 does not cause the screen or view of the page to scroll. Rather, when the scroll cursor 70 is not in contact with one of the edges of the content view 66, the scroll cursor 70 and/or the touch position 68 may move as a normal cursor would be expected to move over the content view 66. However, if the scroll cursor 70 contacts an edge of the content view 66, the scroll function may then be initiated to scroll the page in a direction opposite to the directional edge which has been contacted by the scroll cursor 70, thereby revealing more of the page in the direction of the directional edge that has been contacted.

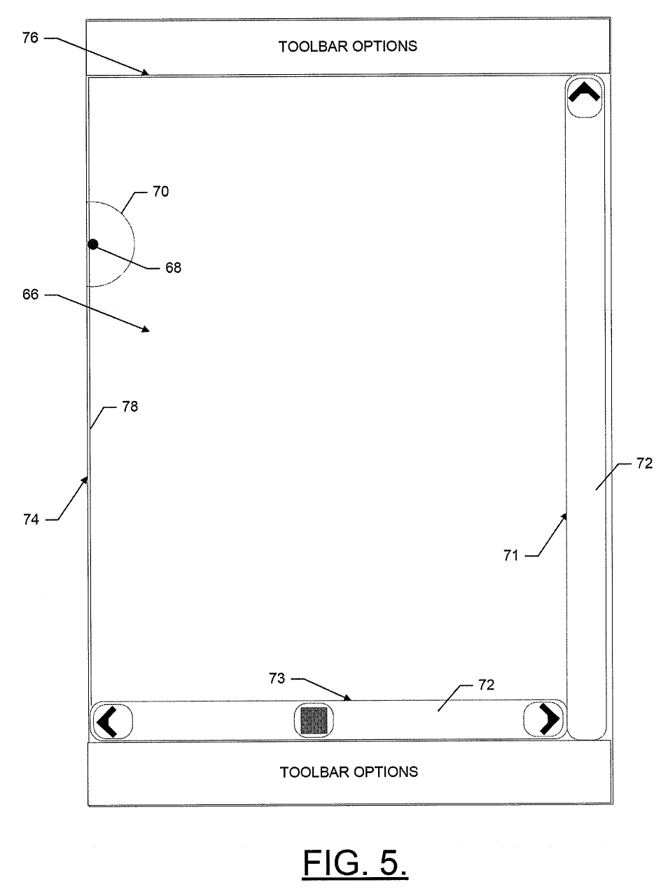

When an edge of the page itself is reached by scrolling (or if the page is already at the edge initially), the scrolling device 64 may be configured to cause the scrolling function to stop. FIG. 5 illustrates an example of a situation where a page edge 78 (i.e., an edge of the page or document being visualized in the content view 66) has reached the left edge 74 of the content view 66. As shown in FIG. 5, although the scroll cursor 70 is positioned for maximum scrolling speed of the page to the right (i.e., a maximum portion of the scroll cursor 70 is in contact with the left edge 74) the page may not scroll since the page edge 78 for the left edge of the page has been reached (i.e., the page edge 78 is substantially aligned with the left edge 74 of the content view 66). Accordingly, for as long as the scroll cursor 70 contacts an edge of the content view 66, scrolling will continue until there is no more content to view in the corresponding direction of scrolling.

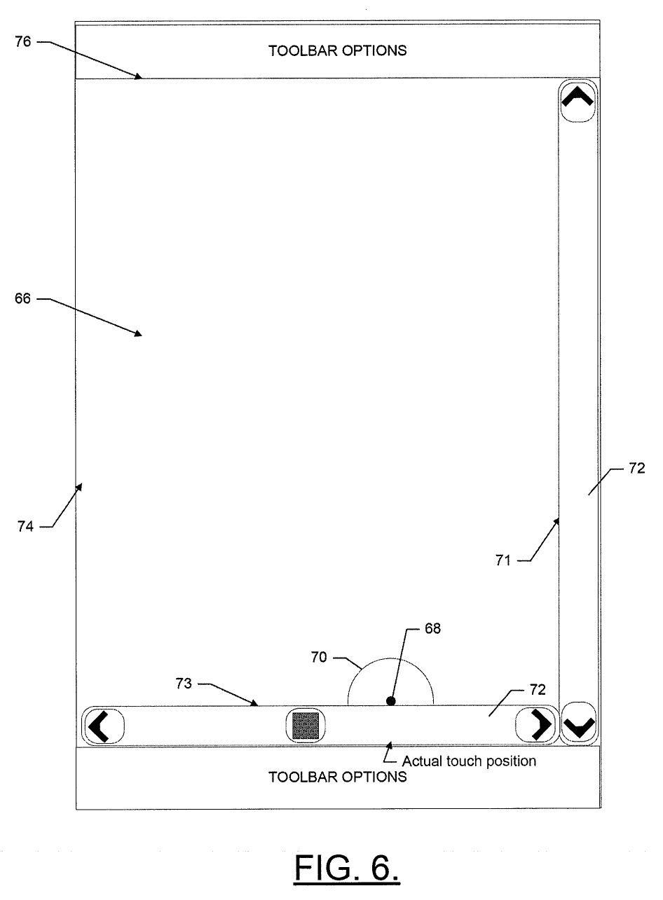

If at any time, the touch event is stopped by lifting the object out of contact with the touch screen display 50, the scrolling device 64 may be configured to stop scrolling the page and the scroll cursor generator 62 may be configured to stop visualizing the scroll cursor 70. However, the scroll cursor 70 may be maintained (and correspondingly scrolling may also be maintained) even though the touch position 68 may extend beyond the edge of the content view 66 such as may be the case, for example, if contact with the touch screen display 50 is maintained despite the contact occurring at a portion of the touch screen display 50 that is obscured by the slider bars 72 as shown, for example, in FIG. 6. In such as situation, the scroll cursor 70 may be displayed relative to the corresponding edge of the content view 66 as if the touch position 68 is at the corresponding edge even though the actual contact point is obscured by the slider bars 72 and therefore is not visualized. In this regard, portions of the scroll cursor 70 that extend beyond the edge of the content view 66 are not visualized or are clipped.

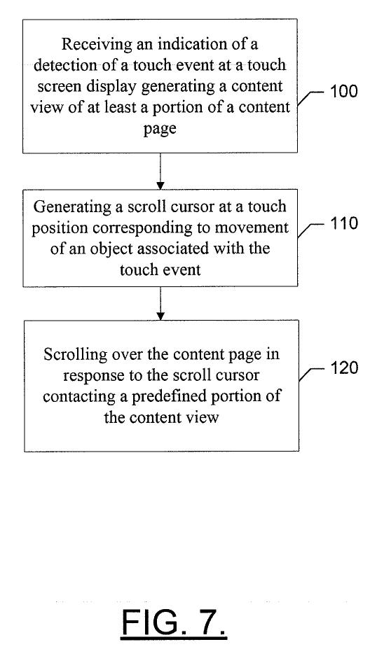

FIG. 7 is a flowchart of a method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, a method according to one embodiment of the invention, as shown in FIG. 7, may include receiving an indication of a detection of a touch event at a touch screen display generating a content view of at least a portion of a content page at operation 100. At operation 110, a scroll cursor may be generated at a touch position corresponding to movement of an object associated with the touch event. Operation 110 may include visualizing a circle of a predefined radius centered on the touch position or generating a graphic element having a size determined based on characteristics of the touch screen display. Alternatively, operation 110 may include generating a graphic element having characteristics determined based on user input. Scrolling over the content page in response to the scroll cursor contacting a predefined portion (e.g., an edge) of the content view may occur at operation 120.

In an exemplary embodiment, operation 120 may include moving the portion of the content page that appears in the content view in a direction substantially opposite to a cardinal direction associated with the edge of the content view with which the scroll cursor is in contact. In this regard, scrolling may be performed until the edge of the content view corresponds to a page edge corresponding to the cardinal direction of the scrolling or until the touch event is terminated by removing the object from contact with the touch screen display. Alternatively, the scrolling may be performed until the scroll cursor moves out of contact with the edge of the display. In an exemplary embodiment, the scrolling over the content page may occur at a speed that is proportional to an amount of the scroll cursor that is in contact with the edge of the content view.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a detection of a touch event at a touch screen display generating a content view of at least a portion of a content page;
generating a scroll cursor at a touch position corresponding to movement of an object associated with the touch event; and
scrolling over the content page in response to the scroll cursor contacting a predefined portion of the content view.

2. A method according to claim 1, wherein generating the scroll cursor comprises visualizing a geometric shape having a predetermined size centered on the touch position.

3. A method according to claim 2, wherein generating the scroll cursor comprises visualizing a circle of a predefined radius centered on the touch position.

4. A method according to claim 1, wherein generating the scroll cursor comprises generating a graphic element having a size determined based on characteristics of the touch screen display.

5. A method according to claim 1, wherein generating the scroll cursor comprises generating a graphic element having a characteristic determined based on user input.

6. A method according to claim 1, wherein scrolling over the content page comprises moving the portion of the content page that appears in the content view in a direction substantially opposite to a cardinal direction associated with an edge of the content view with which the scroll cursor is in contact.

7. A method according to claim 6, wherein scrolling over the content page comprises scrolling over the content page until the edge of the content view corresponds to a page edge corresponding to the cardinal direction of the scrolling.

8. A method according to claim 6, wherein scrolling over the content page comprises scrolling over the content page until the touch event is terminated by removing the object from contact with the touch screen display.

9. A method according to claim 6, wherein scrolling over the content page comprises scrolling over the content page until the scroll cursor is removed from contact with the edge of the content view.

10. A method according to claim 1, wherein scrolling over the content page comprises scrolling over the content page at a speed that is proportional to an amount of the scroll cursor that is in contact with the predefined portion of the content view.

11. A computer program product comprising at least one computer-readable storage medium having computer-readable program code portions stored therein, the computer-readable program code portions comprising:
a first executable portion for receiving an indication of a detection of a touch event at a touch screen display generating a content view of at least a portion of a content page;
a second executable portion for generating a scroll cursor at a touch position corresponding to movement of an object associated with the touch event; and
a third executable portion for scrolling over the content page in response to the scroll cursor contacting a predefined portion of the content view.

12. A computer program product according to claim 11, wherein the second executable portion includes instructions for visualizing a geometric shape having a predetermined size centered on the touch position.

13. A computer program product according to claim 12, wherein the second executable portion includes instructions for visualizing a circle of a predefined radius centered on the touch position.

14. A computer program product according to claim 11, wherein the second executable portion includes instructions for generating a graphic element having a size determined based on characteristics of the touch screen display.

15. A computer program product according to claim 11, wherein the second executable portion includes instructions for generating a graphic element having a characteristic determined based on user input.

16. A computer program product according to claim 11, wherein the third executable portion includes instructions for moving the portion of the content page that appears in the content view in a direction substantially opposite to a cardinal direction associated with an edge of the content view with which the scroll cursor is in contact.

17. A computer program product according to claim 16, wherein the third executable portion includes instructions for scrolling over the content page until the edge of the content view corresponds to a page edge corresponding to the cardinal direction of the scrolling.

18. A computer program product according to claim 16, wherein the third executable portion includes instructions for scrolling over the content page until the touch event is terminated by removing the object from contact with the touch screen display.

19. A computer program product according to claim 16, wherein the third executable portion includes instructions for scrolling over the content page until the scroll cursor is removed from contact with the edge of the content view.

20. A computer program product according to claim 11, wherein the third executable portion includes instructions for scrolling over the content page at a speed that is proportional to an amount of the scroll cursor that is in contact with the predefined portion of the content view.

21. An apparatus comprising:
a detector configured to receive an indication of a detection of a touch event at a touch screen display generating a content view of at least a portion of a content page;
a scroll cursor generator in communication with the detector and configured to generate a scroll cursor at a touch position corresponding to movement of an object associated with the touch event; and
a scrolling device in communication with the scroll cursor generator and configured to provide scrolling over the content page in response to the scroll cursor contacting a predefined portion of the content view.

22. An apparatus according to claim 21, wherein the second executable portion includes instructions for visualizing a geometric shape having a predetermined size centered on the touch position.

23. An apparatus according to claim 22, wherein the scroll cursor generator is further configured to visualize a circle of a predefined radius centered on the touch position.

24. An apparatus according to claim 21, wherein the scroll cursor generator is further configured to generate a graphic element having a size determined based on characteristics of the touch screen display.

25. An apparatus according to claim 21, wherein the scroll cursor generator is further configured to generate a graphic element having a characteristic determined based on user input.

26. An apparatus according to claim 21, wherein the scrolling device is further configured to move the portion of the content page that appears in the content view in a direction substantially opposite to a cardinal direction associated with an edge of the content view with which the scroll cursor is in contact.

27. An apparatus according to claim 26, wherein the scrolling device is further configured to provide scrolling over the content page until the edge of the content view corresponds to a page edge corresponding to the cardinal direction of the scrolling.

28. An apparatus according to claim 26, wherein the scrolling device is further configured to provide scrolling over the content page until the touch event is terminated by removing the object from contact with the touch screen display.

29. An apparatus according to claim 26, wherein the scrolling device is further configured to provide scrolling over the content page until the scroll cursor is removed from contact with the edge of the content view.

30. An apparatus according to claim 21, wherein the scrolling device is further configured to provide scrolling over the content page at a speed that is proportional to an amount of the scroll cursor that is in contact with the predefined portion of the content view.

31. An apparatus comprising:
means for receiving an indication of a detection of a touch event at a touch screen display generating a content view of at least a portion of a content page;
means for generating a scroll cursor at a touch position corresponding to movement of an object associated with the touch event; and
means for scrolling over the content page in response to the scroll cursor contacting a predefined portion of the content view.

32. An apparatus according to claim 31, wherein means for scrolling further comprises means for scrolling over the content page at a speed that is proportional to an amount of the scroll cursor that is in contact with the predefined portion of the content view.
